(19) United States
(12) Patent Application Publication
(10) Pub. No.: US 2015/0318663 A1
(43) Pub. Date: Nov. 5, 2015

(54) SENSING MODULE AND LASER DEVICE

(71) Applicant: Lecc Technology Co., Ltd., Taoyuan County (TW)

(72) Inventor: HSIN-CHIH TUNG, TAO YUAN HSIEN (TW)

(73) Assignee: LECC TECHNOLOGY CO., LTD., Taoyuan County (TW)

(21) Appl. No.: 14/269,132

(22) Filed: May 3, 2014

(51) Int. Cl. H01S 3/13; G01J 1/44

(52) U.S. Cl. CPC H01S 3/1305; G01J 1/44; G01J 2001/446

(57) ABSTRACT

Disclosure is related to a sensing module and a Laser device using the sensing module. The sensing module is adapted to a Laser module. The sensing module essentially includes a beam splitter and a photo sensor. This beam splitter is disposed at an optical-axis path of laser beam. The splitter is used to split the laser beam into a transmissive beam and a reflective beam. The photo sensor however is disposed apart from the optical-axis path of the original laser beam. The photo sensor converts the sensed photo signals into electrical signals which are as feedback signals to the laser module.

### BACKGROUND OF THE INVENTION

1. Field of the Invention

The present invention generally relates to a sensing module and a Laser device; in particular to the Laser device mounting a pluggable sensing module.

2. Description of Related Art

A laser module is generally controllable by two types of mechanisms, namely an automatic current control (ACC) and an automatic power control (APC). The laser module with the control mechanism of automatic current control may provide stable intensity of laser beam since the output current of laser diode is well controlled. However, the operating temperature of the laser module may be raised after long-term operation. The power made by the laser diode may also be declined because of the high temperature.

On the other hand, the mechanism of automatic power control disposes a photo diode into the laser module. The photo diode is used to sense the power of the laser beam from the light source. The sensed information can be fed back to the laser module for modulating the current supplied to the laser diode. Therefore, the laser diode is able to render a stable intensity of power. However, it costs high when the photo diode is integrated with the laser diode, or even packaged in one single module. This process also increases complexity of the laser module.

### SUMMARY OF THE INVENTION

Provided in accordance with the present invention is a sensing module which is applicable to t a laser module. The sensing module exemplarily includes a beam splitter and a photo sensor. The beam splitter is disposed along an optical-axis path of a laser beam. The beam splitter is used to divide the laser beam generated by the laser module into a transmissive beam and a reflective beam. The photo sensor is disposed apart from the optical-axis path of the laser beam. The photo sensor is used to sense the laser beam and convert the optical signals into electrical signals. The photo sensor generates a feedback signal to the laser module.

The Laser device, in accordance with one of the embodiments, includes a sensing module and a laser module. The sensing module also includes a beam splitter and a photo sensor. The beam splitter is disposed apart from the an optical-axis path of laser beam, and used to form a transmissive beam and a reflective beam from the laser beam made by the laser module. The photo sensor is contrarily disposed outside the optical-axis path, and used to sense the laser beam and generate electrical signals. A feedback signal is therefore fed back to the laser module.

The laser module electrically connected with the sensing module. The laser module includes a light-emitting unit, a control unit, and lens. The light-emitting unit is used to generate laser ray. The control unit, electrically connected with the light-emitting unit, is used to adjust intensity of the laser ray. The lens is used to shape the ray to form a concentrated laser beam. The control unit also adjusts the laser intensity according to the feedback signal.

In summation, the sensing module in accordance with the present invention is a pluggable module to be mounted to the laser module. The sensing module allows the laser module to achieve automatic power control when it has no internal photo diode. Therefore, this scheme reduces cost and complexity of the conventional laser module.

### BRIEF DESCRIPTION OF THE DRAWINGS

FIG. 1 shows functional blocks depicting the sensing module according to one embodiment of the present invention;

FIG. 2 shows a schematic diagram describing the pluggable sensing module mounted to a laser module according to one embodiment of the present invention;

FIG. 3A is a graphical representation of outward appearance of the Laser device in accordance with one embodiment of the present invention;

FIG. 3B is a cross-sectional view of the Laser device in one embodiment of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

### Embodiment of Sensing Module

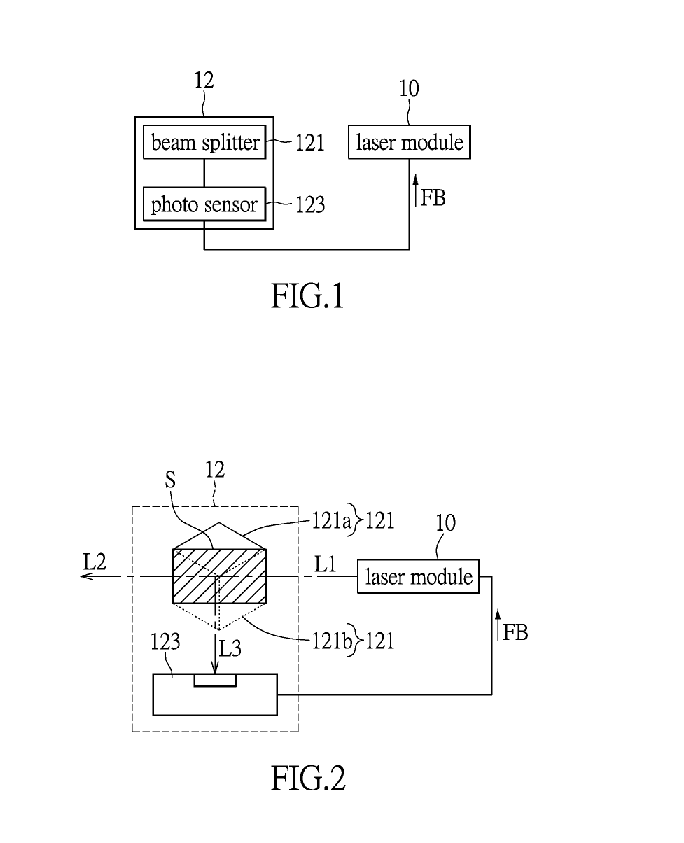

Reference is made to FIG. 1. FIG. 1 shows block diagram depicting a Laser device in accordance with the present invention. A sensing module 12 is applicable to a laser module 10 within the laser device. The sensing module 12 is used to receive a laser beam L1 emitted by the laser module 10. The sensing module 12 exemplarily includes a beam splitter 121 and a photo sensor 123. The beam splitter 121 is disposed along an optical-axis path of the laser beam L1. The beam splitter 121, according to one of the embodiments, is used to divide the laser beam L1 into a transmissive beam and a reflective beam.

Further, the photo sensor 123 is disposed apart from the optical-axis path of the laser beam L1, namely the photo sensor 123 located outside the path for sensing the laser signals. The photo sensor 123 then converts the sensed optical signals to electrical signals so as to generate a feedback signal FB. The feedback signal FB is fed back to the laser module 10.

In detail, such as the schematic diagram referred to FIG. 2, the sensing module is a pluggable module. This pluggable sensing module is made for the conventional laser module.

In an exemplary embodiment, the pluggable sensing module 12 is mounted in front of the laser module 10 for receiving the laser beam L1. When the sensing module 12 senses the laser beam L1, the beam splitter 121 divides the laser beam L1 into two photo beams such as a transmissive beam L2 and a reflective beam L3.

In other words, the photo sensor 123 is located opposite to the beam splitter 121, namely the photo sensor 123 is disposed along the optical-axis path of the reflective beam L3. This disposal allows the photo sensor 123 to be able to sense the reflective beam L3 when the beam splitter 121 divides the laser beam L1 into the transmissive beam L2 and the reflective beam L3. The photo sensor 123 then converts optical signals of the reflective beam L3 into electrical signals. A feedback signal FB is therefore generated, and transmitted to the laser module 10. The laser module 10 is able to stabilize the intensity of laser beam L1 according to the feedback signal FB.

The photo sensor 123 is exemplarily disposed with an element (not shown) enabling a photoelectric effect. When the photo sensor 123 senses the optical signals made by the reflective beam L3, this element converts the optical signals into electrical signals. The device therefore acknowledges the beam intensity from the reflective beam L3. The electrical signals then render a feedback signal FB for the laser module 10.

It is worth noting that, in accordance with the present embodiment, the beam splitter 121 is such as an optical lens allowing transmission and reflection of the beam. That means the beam splitter 121 divides the laser beam L1 made by the laser module 10 into a transmissive beam L2 and a reflective beam L3. Furthermore, the beam splitter 121 is made in combination of two attached prisms 121a and 121b. The each prism 121a or 121b is pyramid-shaped. An oblique plane is formed between the attached prism 121a and prism 121b. A coating S is formed onto the plane, by which the prism 121a and the prism 121b are combined via the coating S. Therefore the combination of two prisms 121a and 121b forms a cubic-structural beam splitter 121. However, this exemplary structure of the beam splitter 121 may not limit the scope of the present invention, but other shapes. The structure of beam splitter 121 may be configured as demands.

It is also noted that the coating S is such as a beam-splitting coating between the prism 121a and the prism 121b. The coating S between the prism 121a and the prism 121b is incorporated to adjusting the ratio of the beam-splitting. That means the various types of the coating onto the beam splitter 121 may result in intensity ratio of the transmissive beam L2 and the reflective beam L3 when the laser beam L1 reaches the beam splitter 121.

Furthermore, the laser module 10 becomes the laser module with automatic current control (ACC) mechanism. In addition, the photo sensor 123 is, but not limited to, a photo diode. The skilled person in the art may design the photo sensor as requires.

### Embodiment of Laser Device

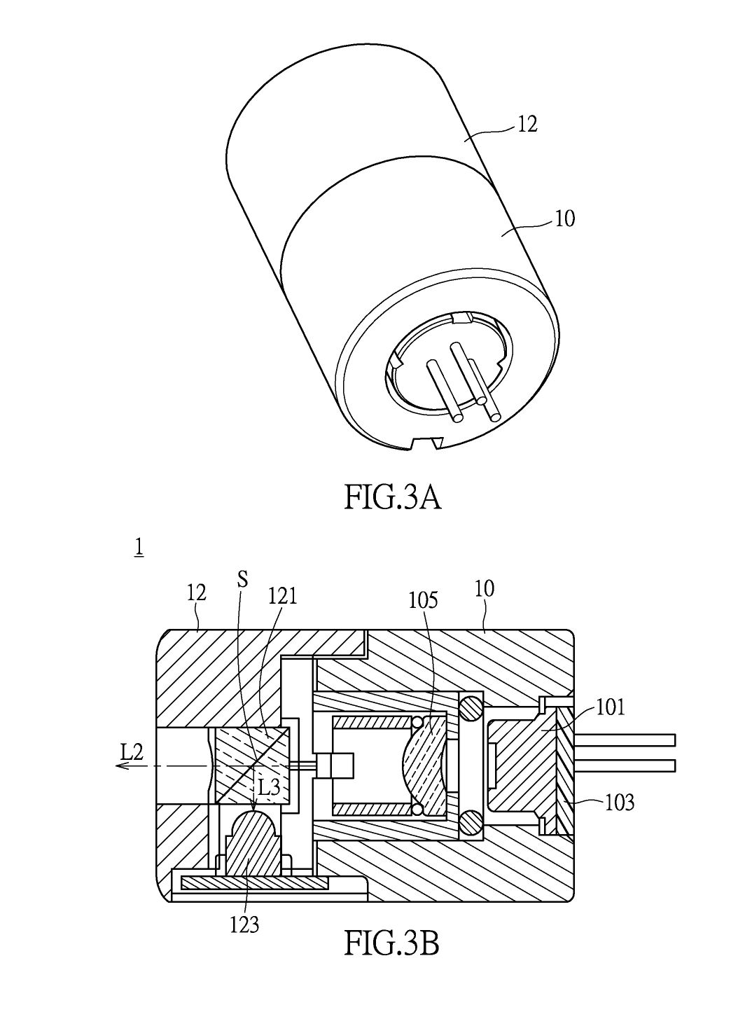

References are made to FIG. 3A and FIG. 3B. FIG. 3A schematically shows an outward appearance of the Laser device in accordance with the present invention. FIG. 3B shows a cross-sectional view of the Laser device.

The Laser device 1 shown in FIG. 3A is cylindrical-shaped. The sensing module 12 is disposed in front of the laser module 10, and able to stabilize intensity of laser beam L1.

It is worth noting that, in accordance with the present embodiment, the structure of sensing module 12 and its implementation is essentially the same with the aforementioned sensing module. Therefore, the following statement uses the same labels indicative of the shown elements for simply depicting the variations between the embodiments. The redundant portion may be ignored without prejudice or disclaimer of any subject matter.

As FIG. 3B shows, the Laser device 1 includes the laser module 10 and the sensing module 12. The laser module 10 is electrically connected with the sensing module 12. The laser module 10 includes a light-emitting unit 101, a control unit 103, and a lens 105. The light-emitting unit 101 is used to radiate laser ray. The control unit 103 is exemplarily disposed behind the light-emitting unit 101. The control unit 103, which is electrically connected with the light-emitting unit 101, is used to adjust intensity of the laser ray. The lens 105 is mounted in front of the light-emitting unit 101, namely along the optical-axis path of the laser beam L1. The lens 105 is employed to shape the laser ray as the laser beam L1. The control unit 103 is used to adjust intensity of the laser ray according to the feedback signal FB generated by the photo sensor 123.

It is noted that the scope of the invention may not be limited to the structure of the light-emitting unit 101 in this embodiment. Further, the light-emitting unit 101 is such as, but not limited to, the laser diode. The skilled person in the art of the subject matter may configure the design as practically requires.

Exemplarily, the light-emitting unit 101 emits laser ray. The laser diode is such as an infrared (IR) laser which radiates IR laser ray. The type or structure of laser diode may not be limited to any specific type. The light-emitting unit 101 is such as the source emitting visible or invisible lights, that means the laser may be visible or invisible.

In addition, the lens is such as a concave-convex lens which is used to shape the laser ray from the light-emitting unit 101 as the laser beam L1. The lens 105 can be any type which allows focusing the laser ray, for example a double-convex lens or a plane-convex lens. The skilled person in the related art may have the design as practically demands.

It is noting that the laser module 10 is such as the module with automatic current control, namely the ACC-type laser module.

The Laser device 1 is described as follows. Reference is made to FIG. 3B, the sensing module 12 is disposed in front of the laser module 10, preferably mounted onto the front of the laser module 10. The light-emitting unit 101, lens 105, and the beam splitter 121 are oppositely disposed, and preferably along the optical-axis path of the laser beam L1. In addition, the photo sensor 123 is located at the optical-axis path of the reflective beam L3.

In an exemplary embodiment, when the Laser device 1 is powered on, the light-emitting unit 103 is activated to emit laser ray. The ray is shaped by the lens 105 to form the laser beam L1. The beam splitter 121 splits the entered laser beam L1 into a transmissive beam L2 and a reflective beam L3. The transmissive beam L2 emits out of the Laser device 1. The photo sensor 123 accepts the reflective beam L3, and accordingly converts the signals into electrical signals. A feedback signal FB is therefore generated for the control unit 103. The control unit 103 adjusts electric current to drive the light-emitting unit 101 in order to stabilize intensity of the laser beam L1 according to the feedback signal FB.

For example, the photo sensor 123 may generate relatively weak signal for the control unit 103 when it receives weak reflective beam L3. The feedback signal FB indicating this weak signal is generated to the control unit 103. The control unit 103 accordingly raises the electric current for the light-emitting unit 101 in accordance with the present example. The raising current also increases the intensity of laser beam L1 for fitting the requirement. Oppositely, the photo sensor 123 outputs larger electrical signals which reflect the photo sensor 123 receiving stronger reflective beam L3. The photo sensor 123 correspondingly generates the feedback signal FB for the control unit 103. The control unit 103 may decrease intensity of laser beam L1 when the feedback signal FB indicates a low current required to the light-emitting unit 101 for a specific purpose made by users.

Thus, while the sensing module 12 is mounted onto the laser module 10, the laser module 10 may always outputs the laser beam L1 with a stable power even though under different temperatures and long-term use. The additional mounted sensing module 12 allows the laser module 10 to operate as the general laser module with automatic power control (APC) mechanism in condition of no internal photo sensor 123. Both types of the laser module 10 with or without the automatic power control mechanism are able to output the stabilized laser beam L1.

### Effect of the Present Invention

To sum up, the disposal of the sensing module onto the Laser device in accordance with the present invention is such a concept of pluggable module when the sensing module is pluggable onto the laser module. Even though the conventional laser module having no internal photo diode which is generally used to estimate the laser intensity, such the laser module is able to achieve the laser module with the automatic power control mechanism, namely the APC-type laser module. Furthermore, the complexity of the laser module may be effectively reduced when no photo diode is disposed inside the laser module. The cost of the whole design may also be reduced.

Thus, the cost of the laser module without automatic power control mechanism may be effectively reduced when the sensing module is additionally pluggable to the laser module in accordance with the present invention. The drawback of the conventional laser module with the automatic current control mechanism can be improved. By the scheme of the present invention, the conventional ACC-type laser module operates as the APC-type laser module with the budgeted consideration.

It is intended that the specification and depicted embodiment be considered exemplary only, with a true scope of the invention being determined by the broad meaning of the following claims.

1. A sensing module adapted to be mounted to a laser module, comprising:
a beam splitter, disposed at an optical-axis path of a laser beam, used for the laser module to split the laser beam into a transmissive beam and a reflective beam; and
a photo sensor, disposed apart from the optical-axis path of the laser beam, wherein the photo sensor senses the laser beam and converts sensed photo signals into electrical signals, for generating a feedback signal to the laser module;
wherein the laser beam generated by the laser module is unobstructedly and directly projected onto the beam splitter to form the transmissive beam and the reflective beam.

2. The sensing module of claim 1, wherein the beam splitter is made in combination of two prisms.

3. The sensing module of claim 2, wherein the combination of the two prisms exists an oblique plane there-between, and a coating is formed on the oblique plane so as to form a cubic structure.

4. The sensing module of claim 1, wherein the photo sensor is a photo diode.

5. The sensing module of claim 2, wherein the one prism is pyramid-shaped.

6. A laser device, comprising:
a laser module, having:
a light-emitting unit, used to emit a laser beam;
a control unit, electrically connected with the light-emitting unit, used to adjust intensity of the laser beam; and
a lens, used to shape the laser beam; and
a sensing module, having:
a beam splitter, disposed at an optical-axis path of the laser beam, used to split the laser beam into a transmissive beam and a reflective beam; and
a photo sensor, disposed apart from the optical-axis path of the laser beam, used to sense the laser beam and convert sensed photo signals into electrical signals, so as to generate a feedback signal;
wherein the laser beam generated by the laser module is unobstructedly and directly projected onto the beam splitter to form the transmissive beam and the reflective beam;
wherein, the control unit of the laser module adjusts laser intensity in response to the feedback signal.

7. The laser device of claim 6, wherein the beam splitter is made in combination of two prisms.

8. The laser device of claim 7, wherein the combination of the two prisms exists an oblique plane there-between, and a coating is formed on the oblique plane so as to form a cubic structure.

9. The laser device of claim 6, wherein the light-emitting unit is a laser diode.

10. The laser device of claim 7, wherein the one prism is pyramid-shaped.

11. A sensing module adapted to be mounted to a laser module, comprising:
a beam splitter, disposed at an optical-axis path of a laser beam, used for the laser module to split the laser beam into a transmissive beam and a reflective beam; and
a photo sensor, disposed apart from the optical-axis path of the laser beam, wherein the photo sensor senses the laser beam and converts sensed photo signals into electrical signals, for generating a feedback signal to the laser module;
wherein the laser beam generated by the laser module is unobstructedly and directly projected onto the beam splitter to form the transmissive beam and the reflective beam;
wherein the beam splitter includes two prisms and a beam-splitting coating between the two prisms for adjusting an intensity ratio of the transmissive beam and the reflective beam of the laser beam;
wherein the sensing module is pluggable onto the laser module.
